(19) United States
(12) Patent Application Publication
(10) Pub. No.: US 2025/0170497 A1
(43) Pub. Date: May 29, 2025

(54) FLOW DISTRIBUTOR AND VOID REDUCTION DEVICE

(71) Applicant: MERCK MILLIPORE LTD., Carrigtwohill, County Cork (IE)

(72) Inventors: Sean Foley, Marlborough, MA (US); Kevin Rautio, Manchester-by-the-Sea, MA (US); Philip M. Goddard, Merrimack, NH (US); Angela Moser, Somerville, MA (US)

(21) Appl. No.: 18/844,317

(22) PCT Filed: Jun. 22, 2023
(86) PCT No.: PCT/US2023/068870

§ 371 Date: Sep. 5, 2024

Related U.S. Application Data
(60) Provisional application No. 63/366,933, filed on Jun. 24, 2022.

(51) Int. Cl. B01D 15/22; B01D 63/08; B01D 71/28; B01D 71/52

(52) U.S. Cl. CPC B01D 15/22; B01D 63/0822; B01D 71/281; B01D 71/5223; B01D 2313/26

(57) ABSTRACT

A filter plate device has an inlet and an outlet where the filter plate has a polymeric framework having a filtration zone and a membrane bed of one or more membranes bonded and sealed to the polymeric framework in said filtration zone with a thermosetting plastic, where a flow distributor is placed within the membrane bed such that fluid flows evenly through the membrane bed.

### CROSS-REFERENCE TO RELATED APPLICATION

The present application claims the benefit of priority of U.S. Provisional Application No. 63/366,933, filed Jun. 24, 2022, the entire content of which is incorporated herein by reference.

### FIELD

In general, the present disclosure is directed to chromatography units, and in particular, to a disposable or single-use chromatography devices with a flow distributor enabling less dynamic flow on the upstream side of the device to aid in reduction of elution volume and/or elution tailing.

### BACKGROUND

Good manufacturing practices and governmental regulations are at the core of many biopharmaceutical manufacturing process. Such manufacturing processes must often undergo mandated, often lengthy and costly validation procedures. For example, the equipment used for the separation and purification of biopharmaceutical products must, for obvious reasons, meet stringent cleanliness requirements. For a single piece of equipment, the associated and reoccurring cost of a single cleaning validation may readily exceed multiple thousands of dollars. To reduce such cleaning validation costs and expenses, and/or to reduce the occasions when cleaning is needed or required, the pharmaceutical and biotech industries are increasingly exploring pre-validated modular, disposable solutions.

Along these lines, there is considerable interest of late in developing a disposable solution to the primary and/or secondary clarification of industrial, laboratory and clinical volumes of raw, pharmaceutically synthesized fluids (e.g., cell cultures). The high-volume, high-throughput requirements of such processes generally favor the use of costly, installed stainless steel apparatus, wherein replaceable cassettes or cartridges (e.g., typically comprising stacks of lenticular filter elements) are installed within a stainless steel housing or like receptacle. At the conclusion of a filtration operation, and removal of the spent cassette or cartridge, the apparatus has to be cleaned and validated, at considerable cost and effort, prior to being used again.

Membrane based devices designed for use in the biopharmaceutical processing industry are typically constructed of all thermoplastic components. This is desirable because the thermoplastics of choice (e.g., polypropylene, polyethylene, polyethersulphone, etc.) are stable in the chemicals and environment they are exposed to. One negative aspect of all thermoplastic devices that utilize secondary molding operations during manufacture is shrinkage. As the thermoplastic cools, it shrinks, thus warping the membrane and creating undesirable voids.

More specifically, thermoplastic filtration devices have been conventionally manufactured using an over-molding step where, a “window frame” of thermoplastic (typically polypropylene) is injection molded around the periphery of a rectangular piece of membrane or media, then a bonding step (vibration, hotplate, etc.) is used to attach the subassemblies and, finally, endcaps are welded in a similar fashion. In flow-through applications where the separation mechanism is either size exclusion or charge based, the additional void inside the device that is created by the “window frame” shrinking as it cools (and wrinkling the membrane or media), does not negatively affect the device performance. However, in bind and elute mode applications for capture in a chromatography train, any additional void created by a wrinkled membrane will reduce the performance of the device. This performance reduction can be seen in the sharpness of the breakthrough curve and in the efficiency of the elution.

In addition, to increase the efficiency of the device and reduce end product loss, it is important to minimize the devices dynamic flow volume thus decreasing the dead volume. This decreased dead volume will in turn reduce the volume of elution material needed at the end of the elution cycle of the device thereby reducing elution materials, volumes, costs, and environmental impact of the device and/or process.

It therefore would be desirable to have a bind and elute device using a flow distributor and/or a void reduction element to fill a space in the membrane plate subassembly that is less dynamic (less dead space) in the device compared to normal bind and elute chromatography devices.

For further understanding of the nature and these and other objects of the present invention, reference should be had to the following description considered in conjunction with the accompanying drawings.

### SUMMARY

Problems of the prior art have been addressed by embodiments disclosed herein, which relate to a disposable or single-use integral chromatography unit having an inlet and an outlet, and comprising one or more plates or pairs of filter plates interposable between a pair of end plates with a flow distributor and/or a void reduction element between the plates on the upstream side of the membrane bed contained in the filter plates. In certain embodiments, each of the filter plates comprises a polymeric framework with one or more membranes supported therein, which may include screens or spacers that separate each layer of membrane where the screens or spacers further comprise a rib structure or screen shape that reduces the amount of dead space contained within the membrane bed. The filter plates and end plates may be assembled to form a substantially fixed, substantially water-tight, integral stack. Fluid entering the unit through a common inlet passes the membrane or membranes of each filter plate containing the rib structure or enhanced screen shape substantially contemporaneously prior to exiting the unit through a common outlet (cf., “parallel” flow). The assembly is a modular design, as multiple pairs of plates can be stacked in a suitable holder to form a single chromatography unit that contains less dead space.

Also disclosed are methods of manufacturing such filter plates and chromatography units.

### BRIEF DESCRIPTION OF THE DRAWINGS

FIG. 1 is a top and front view of a flow distributor for a single use flat plate device, shown removed from the membrane stack, in accordance with certain embodiments;

FIG. 2 is a cross-section view of a flat plate device shown without a flow distributor in the membrane stack, in accordance with certain embodiments;

FIG. 3 is a cross-section view of a flat plate device with a flow distributor inserted into the membrane stack, in accordance with certain embodiments;

FIG. 4 is a loading curve (normalized UV vs. MV (membrane volume)) comparing an elution tailing fix without and without a flow distributor in accordance with certain embodiments;

### DETAILED DESCRIPTION

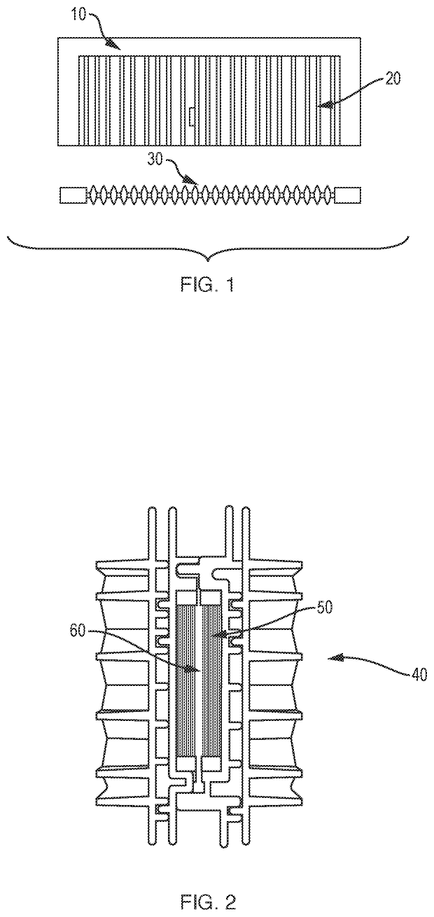

Turning now to FIG. 1, there is shown a flow distributor 10 in accordance with certain embodiments. The flow distributor 10 may have a generally rectangular shape to fit between membrane or membrane stacks. The flow distributor 10 is preferably made of a polymeric material to which the thermoset used to adhere the membrane or membranes adheres well to, and which itself can be heat weldable so that the flow distributor 10 can be bonded to other portions of a chromatography device. Suitable polymeric materials include resins such as amorphous blends of polyphenylene ether and polystyrene commercially available from SABIC, such as NORYL resin HNA033, which is a non-reinforced blend of polyphenylene ether and high impact polystyrene. Epoxy bonds well to these resins, which enables the use of low shrink materials and a membrane that is not dry.

a. In certain embodiments, each flow distributor 10 consists of one or more or a series of ribs 20 that are substantially parallel to the membrane surface. The rib 20 has a axial profile 30 that be shaped in a multitude of ways including but not limited to square, triangular, circular, elliptical, pentagonal, hexagonal, octagonal, decagonal, dodecagonal, or irregularly shaped. Fluid that flows through the device is directed by the rib and flows to into the device substantially contemporaneously (i.e., in “parallel”) prior to exiting the unit or in such a manner as to reduce the void volume of the chromatography device, reducing the amount of elution material needed to elute the materials captured by the chromatography membrane of the device.

The flow distributor 10 can be implemented at a relatively low cost. In particular, the flow distributor 10 can be made as an inexpensive component of a “single use” item, i.e., “single use” in the sense that at the completion of the desired (or predetermined) operation, the device can either be disposed of (e.g., as is sometimes required by law after filtering certain environmentally-regulated substances) or partially or completely revitalized or recycled (e.g., after filtering non-regulated substances).

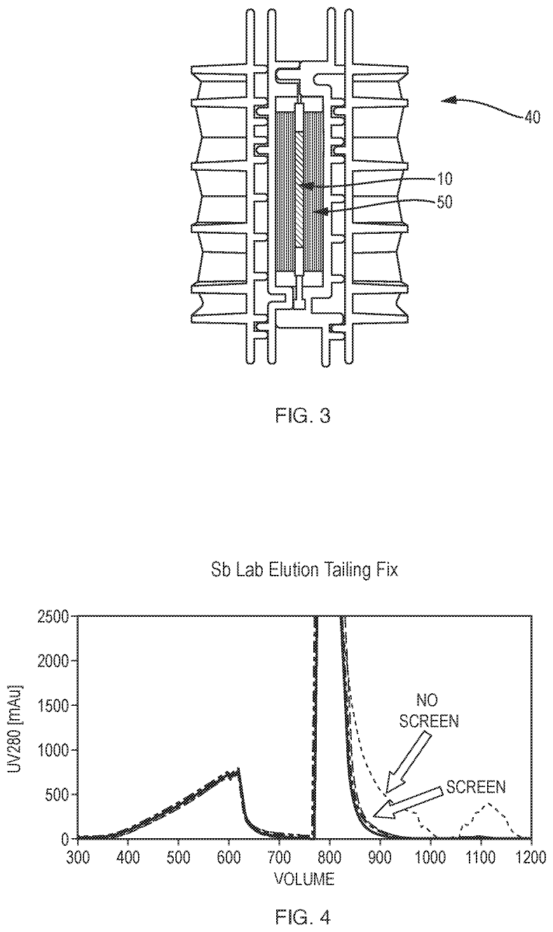

FIGS. 2 and 3 depict cross-sectional views of a chromatography device 40 that has been cut in half. The chromatography device can be molded from the same or similar compatible materials as the flow distributor 10. In FIGS. 2 and 3, the membrane or membrane stacks 50 are located in the middle of the device 40. The center 60 of the membrane stack 50 is where flow of the chromatography liquids are introduced to the membrane stack 50. FIG. 2 contains no flow distributor 10. FIG. 3 shows the flow distributor 10 located between the membrane stacks 50 in the center 60. In the embodiment shown in FIG. 3, the flow is distributed along the vertical and horizontal lengths of the flow distributor 10 such that the volume of dead space within the center 60 is minimized and liquid is then delivered to the membrane stacks 50 in a more efficient manner. Suitable membranes include those suitable for bind/elute chromatography and including a ligand, such as a Protein A ligand, attached thereto. In certain embodiments, the membrane stack 50 is a wet membrane that is not dryable, such as a porous hydrogel. Suitable membranes include those disclosed in U.S. Pat. Nos. 7,316,919; 8,206,958; 8,383,782; 8,367,809; 8,206,982; 8,652,849; 8,211,682; 8,192,971; and 8,187,880, the disclosures of which are hereby incorporated by reference. Such membranes include composite materials that comprises a support member that has a plurality of pores extending through the support member and, located in the pores of the support member and essentially filling the pores of the support member, a macroporous cross-linked gel. In some embodiments, the macroporous gel used is responsive to environmental conditions, providing a responsive composite material. In other embodiments, the microporous gel serves to facilitate chemical synthesis or support growth of a microorganism or cell.

In certain embodiments, the bonding (or overmolding) agent is a polymer with low shrink properties (<0.7%) and one that will readily bond to the support plate material. In this example, the support plate material is PPO (Poly(p-phenylene oxide)). The membrane stack may be adhered by overmolding the same material (PPO) or a more readily moldable and low shrink component of PPO, High Impact Polystyrene. The overmolding process will encapsulate and seal the membrane stack and bond it to the plate. The selection of low shrink materials will minimize shrink which will minimize warpage and movement of the components and result in the high quality chromatographic properties desired.

In certain embodiments, the membrane or membrane stacks 50 are adhered and sealed to the polymeric framework with an over-molding process to effectively encapsulate the membrane or membrane stacks 50 in the framework around the flow distributor 10 such that all of the fluid entering the inlet of the device must pass through the flow distributor 10 and then on to the membrane or membrane stacks 50 before it reaches the outlet of the device.

In certain embodiments, the bonding agent in the device 40 is a thermoset or thermosetting plastic. Thermosets strengthen during heating, which is in contrast to thermoplastics, which soften when heated and harden and strengthen after cooling. Thermosets also retain their strength and shape when heated, again unlike thermoplastics, and exhibit excellent strength characteristics even at high temperatures. One suitable thermoset is TW062601 commercially available from EpoxySet Inc. This thermoset is a two-component encapsulating material, which cures to a hard, resilient polymer, and upon curing, adheres well to the polymeric framework of which the flow distributor 10 may be made.

### EXAMPLE

### Materials and Methods

Chromatography devices fabricated as described in this disclosure, of varying membrane volumes (MVs) ranging from 1 mL up to 112 mL, were evaluated for dynamic bind and elute chromatographic performance. Chromatographic performance of the devices was run on either an ÄKTA™ Avant 150 (GE Healthcare, Uppsala, Sweden) or a K-Prime® 40-III (EMD Millipore, MA, USA) chromatography system at a flowrate of 10 MVs/min.

The equilibration buffer used in this study was 20 mM phosphate, pH 7.0. Human gamma globulin (IgG) lyophilized powder (SeraCare Life Sciences, MA, USA, catalogue #1860-0048), was mixed with a 20 mM phosphate, 50 mM sodium chloride, pH 7.0 buffer to make an IgG solution with an IgG concentration between 2.7-3.0 g/l. IgG concentration was verified by UV absorbance at 280 nm with a UV-vis spectrophotometer. The elution buffer used in this study was 100 mM citric acid, pH 2.5.

Phosphate (monohydrate and disodium phosphate), sodium chloride, and citric acid were procured from Sigma Aldrich (St Louis, MO, USA). All solutions were filtered before use, through a 0.22 μm polyethersulfone hydrophilic filter unit (EMD Millipore, MA, USA).

Devices were equilibrated with 20 mM phosphate, pH 7.0. Then the IgG solution was loaded onto the device to at least 10% breakthrough. As the IgG solution flows through the device, the IgG binds specifically to the membrane contained in the device, while other contaminants flow through or bind nonspecifically to the membrane. Next, a wash step was performed sequentially to remove nonspecifically bound species in the device by washing the device with 20 mM phosphate buffer. Following the wash step, the specifically bound IgG of interest was recovered from the device using a 100 mM citric acid elution buffer. A final wash step using equilibration buffer followed to re-equilibrate the device.

FIG. 4 illustrates the chromatographic performance in devices ranging from 1 ml (407 A), to 10 ml (10 ml-H) and 112 ml (XL-04, XL-05) in volume with and without the flow distributor (labeled as screen). The breakthrough curves illustrate the significantly reduced tailing for a device with a flow distributor versus the higher tailing for a device without a flow distributor. For devices with higher tailing, higher elution volumes are then necessary at the end of the elution cycle, typically sodium hydroxide (NaOH). Thus, elution devices with flow distributors use less NaOH per elution cycle and thus are more environmentally friendly as well as less expensive to run.

What is claimed is:

1. A filter plate device having an inlet and an outlet, said filter plate comprising a polymeric framework having a filtration zone and a membrane bed of one or more membranes bonded and sealed to said polymeric framework in said filtration zone with a thermosetting plastic, wherein a flow distributor is placed within the membrane bed such that fluid flows evenly through the membrane bed.

2. The filter plate device of claim 1, wherein said polymeric framework comprises a polyphenylene ether/polystyrene blend.

3. The filter plate device of claim 1, wherein the flow distributor has a plurality of shapes along a vertical axis of the flow distributor to assist fluid dispersion into the filtration zone.

4. The filter plate of claim 3, wherein said shapes can be square, triangular, circular, elliptical, pentagonal, hexagonal, octagonal, decagonal, dodecagonal, or irregular.

5. A chromatography unit having an inlet and an outlet, and comprising at least one pair of filter plates interposed between a pair of end plates; each of said filter plates of said at least one pair of filter plates comprising a polymeric framework having a filtration zone and a membrane bed with one or more membranes bonded to said polymeric framework in said filtration zone with a thermosetting plastic wherein a flow distributor is placed within the membrane bed such that fluid flows evenly through the membrane bed; the filter plates of said at least one pair of filter plates being placed in back-to-back relation thereby creating a channel between the membrane or membranes in a first plate of said pair and the membrane or membranes in a second plate of said pair, into which fluid flows evenly from said inlet and exits through said outlet after passing through the membrane or membranes in each of said first and second plates.

6. The chromatography unit of claim 5, wherein said polymeric framework comprises a polyphenylene ether/polystyrene blend.
